(19) United States
(12) Patent Application Publication
(10) Pub. No.: US 2010/0206007 A1
(43) Pub. Date: Aug. 19, 2010

(54) METHOD FOR PRODUCING A HEADLIGHT LENS FOR A VEHICLE HEADLIGHT

(76) Inventors: Hagen Goldammer, Jena (DE); Alois Wilke, Buseck (DE); Wintzer Wolfram, Jena (DE)

Correspondence Address: BARNES & THORNBURG LLP, 11 SOUTH MERIDIAN, INDIANAPOLIS, IN, 46204, US

(21) Appl. No.: 12/678,174

(22) PCT Filed: Sep. 14, 2008
(86) PCT No.: PCT/DE08/01525

§ 371 Date: May 4, 2010

(30) Foreign Application Priority Data
Sep. 18, 2007 (DE) 10 2007 044 517.4

(51) Int. Cl. C03B 23/00

(52) U.S. Cl. 65/102

(57) ABSTRACT

The invention relates to a method for producing a headlight lens (51) for a vehicle headlight, characterized in that a blank (20) made of glass is heated and thereafter pressed into an injection die (30) to form a headlight lens (51).

The invention relates to a method for producing a headlight lens for a vehicle headlight from a blank of glass.

PCT/DE 2007/000251 discloses a method for producing a technical glass part or element, in particular with respect to high requirements in terms of contour accuracy and/or surface quality, particularly a precision lens, wherein a blank is manufactured by means of an injection-pressing process, wherein the blank is cooled and subsequently heated, and wherein the blank is subsequently blank-moulded into a technical glass article in particular meeting high requirements regarding contour accuracy and/or surface quality, particularly a precision lens, said blank-moulding particularly occurring on both sides.

DE 103 23 989 B4 discloses an apparatus for performing a process for manufacturing blank-moulded glass bodies for optical equipment, wherein a liquid glass gob is supplied to a levitation pre-mould into which the glass gob is pre-formed into a pre-form or blank without contacting the pre-mould, which pre-form is transferred to a separate pressing mould after a defined period of time has passed, and is pressed therein by means of a moulding or pressing tool into the final form, wherein the transfer of the pre-form to the pressing mould occurs in such a way that the pre-form falls into the pressing mould from the pre-mould in a free fall, wherein, for delivering the glass gob, the pre-mould is shifted over the pressing mould, is stopped in this transfer position and is pivoted away from the glass gob in a downward direction, said apparatus comprising two indexing turntables, one of which includes circularly arranged pre-moulds for forming said pre-forms or blanks from a liquid glass gob, which pre-moulds have, in the lower region thereof, minor openings for introducing an air cushion, while the other one (of which) has circularly arranged pressing moulds for pressing the pre-forms after having been delivered from the pre-moulds, and wherein each pre-mould is attached to the first indexing turntable by means of a switchable holder which holds the pre-mould horizontally in a first indexing or switching position and in a second indexing or switching position, which is a position enabling the free fall of the pre-forms or blanks.

DE 101 40 626 B4 discloses a method for producing a press-moulded glass body, in which liquid molten glass mass is poured into a mould in which it is pressed by means of a pressing die or ram and cooled down, and subsequently the press-moulded glass body is taken out of the mould, wherein the liquid molten glass mass in the mould is subjected to plural pressing operations, wherein cooling takes place between the pressing operations, and wherein at least once between the pressing operations heating of the outer regions of the glass mass is performed such that the cooling of the glass mass in the outer region is adapted to the cooling action in the core.

DE 102 34 234 A1 discloses a method for blank-moulding a glass body for optical applications using a pressing mould comprising an upper mould and a lower mould and optionally a ring, which pressing mould is adapted to receive the glass body heated to a temperature above its deformation temperature, to which glass body an electrical voltage is applied between the upper mould and the lower mould and to which glass body a compression pressure is applied at the latest after adapting the temperature of the glass body to the temperature of the pressing mould.

DE 103 48 947 A1 discloses a press for heat-moulding optical elements from glass using means for heating a form block comprising an upper mould, a lower mould and a guide ring, which form block receives the glass material, wherein inductive heating is provided as heating means, and wherein the form block is arranged on top of a thermally insulating body during the heating process.

DE 196 33 164 C2 discloses a process and an apparatus for blank-moulding optical components for illumination purposes at least on one side, wherein at least one mechanically portioned glass part or element is transferred to at least one annular-shaped receptacle adapted to be moved out of at least one furnace by means of a gripper, and is moved into the furnace by the receptacle and heated in the same on the receptacle, wherein the heated glass part is moved out of the furnace by the reception and is transferred back to the gripper which leads the heated glass part to a press for at least one-sided blank-moulding, and wherein the blank-moulded glass part is then taken out of the press, transferred to a cooling zone and carried away from the same.

DE 103 60 259 A1 discloses a process for blank-moulding optical elements made from glass, in which process a glass gob, which is situated in a mould block is heated to a temperature T lying above its transformation temperature T_{G}, and in which process the glass gob is pressed and cooled to a temperature below T_{G}, wherein the cooling is initially performed in a first temperature interval lying above T_{G}, at a first cooling rate and subsequently in a second temperature interval which includes T_{G} using a second cooling rate, and wherein, for adjusting the first and second cooling rates active cooling is performed.

DE 44 22 053 C2 discloses a process for manufacturing shaped glass forms, wherein, in a pressing station, molten liquid glass is pressed into a pressing mould providing the outer shape of the shaped product by means of a pressing ram or die defining the inner shape of the shaped glass product, wherein the pressing ram or die, after the pressing process remains in contact with the shaped glass form only long enough, and wherein heat is enabled to be dissipated from the surface of the glass form until the shaped glass product has cooled down, in its region close to the surface to a temperature such that it has obtained sufficient structural stability (rigidity) of the surface for being removed from the pressing mould, and wherein the glass form is subsequently taken out of the pressing mould and transferred to a cooling station, before it becomes deformed due to partial heating and the shaped glass product will be cooled down in the cooling station until it is completely solidified.

Further processes and apparatuses for manufacturing optical components are disclosed, for example, in U.S. Pat. No. 5,885,316, GB 1 336 613, DE 2 024 082, JP 09132417A, JP 10251030 A, EP 1 584 863 A2 and EP 0 078 658 B2. Injection press-moulding is further known from U.S. Pat. No. 046,540.

It is an object of the invention to provide a process for manufacturing headlight lenses having more complex surface contours, from glass. Herein, it is particularly desirable to define a process for the manufacturing of (zones providing) light dispersing lenses for vehicle headlights. It is further desirable to manufacture the headlight lenses, particularly as small (batch) series, in a cost-efficient manner.

The aforementioned object is achieved by a process for manufacturing a headlight lens for a vehicle headlight, in particular for a motor vehicle headlight, wherein a blank of glass is heated, and wherein the blank is pressed after heating in an injection pressing mould into a headlight lens.

A blank of glass in the sense of the invention is, in particular, a gob. A blank of glass in the sense of the invention consists, in particular, of inorganic glass. A blank in the sense of the invention is, in particular, to be distinguished from a liquid drop of glass. A blank of glass in the sense of the invention is defined by its mass, i.e. it has a defined mass. Appropriate glass species for the blank are e.g. B270, F2, DOCTAN® and borosilicate glass.

An injection-pressing mould in the sense of the invention is, in particular, defined in that an opening through which the blank is pressed into the injection-pressing mould has a smaller cross-sectional surface than at least a portion of the mould cavity of the injection-pressing mould. An injection-pressing mould in the sense of the invention is alternatively or additionally defined in particular in that it has a first cross-sectional face or area of the mould cavity of the injection-pressing mould and at least a second cross-sectional face or area of the mould cavity of the injection-pressing mould, wherein the second cross-sectional face is situated closer to an opening of the mould cavity through which the blank is pressed into the injection-pressing mould, than the first cross-sectional face, and wherein the first cross-sectional face is larger than the second cross-sectional face. An injection-pressing mould in the sense of the invention is in particular an at least two-part mould.

A headlight lens in the sense of the invention is in particular a (zones forming or providing) light dispersing lens. An example of a light dispersing lens may e.g. be taken form DE 696 36 270 T2. A headlight lens in the sense of the invention is, in particular, a lens in which the optically effective surfaces cover more than half, in particular a predominant portion of the surface of the headlight lens.

In an advantageous embodiment of the invention the blank is heated such that it obtains a viscosity between 10⁴ Pa*s and 10⁵ Pa*s, in particular between 10⁴ Pa*s and 5·10⁴ Pa*s. In a further advantageous embodiment of the invention the blank is heated on a cooled lance.

In a still further advantageous embodiment of the invention the blank is heated such it obtains an essentially homogeneous viscosity. An essentially homogeneous viscosity in the sense of the invention is, in particular, to mean that the viscosity within the blank should not vary by more than 20%, particularly by not more than 10%. Herein, however, a higher fuctuation of the viscosity may be provided with respect to the support surface on which the blank has been placed. In other words, an essentially homogeneous viscosity of the blank, in particular, means that apart from a support surface of the blank there is, within the blank, a viscosity variation of not more than 20%, in particular not more than 10%.

In a yet further advantageous embodiment of the invention the blank is pressed into the injection pressing mould from below (downwardly). In an even further advantageous embodiment of the invention the injection pressing mould is opened for removing the pressed headlight lens by means of a linear movement. In this context, it is specifically provided that two partial moulds are moved away from each other by a linear movement. Herein, a linear movement is particularly to be distinguished from a hinged opening action.

In a still further advantageous embodiment of the invention the headlight lens is pressed in the injection-pressing mould with a moulded-on or cast-on section or sprue. In an even further advantageous embodiment of the invention the headlight lens is, after pressing, cooled by adding heat, wherein it is advantageously provided that said sprue/section is removed after the cooling of the headlight lens. Herein, the headlight lens is, in a yet further advantageous embodiment of the invention, either held in a hanging position or erected by means of a stand foot, during cooling.

A motor vehicle in the sense of the invention is in particular a land craft to be used individually in road traffic. Motor vehicles in the sense of the invention are in particular not restricted to land craft having an internal combustion engine.

Further advantages and details may be taken from the following description of examples of embodiment. In this context, there is shown in:

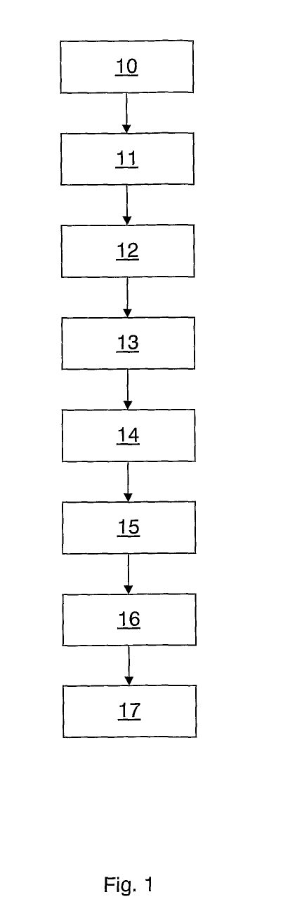

FIG. 1 a process for manufacturing a headlight lens for a vehicle headlight, in particular for a motor vehicle headlight,

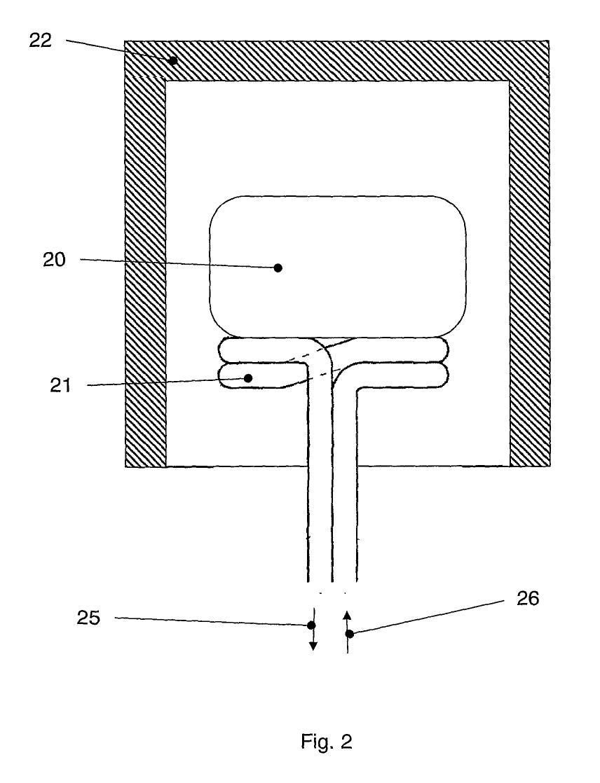

FIG. 2 an example of embodiment of a furnace for heating a blank,

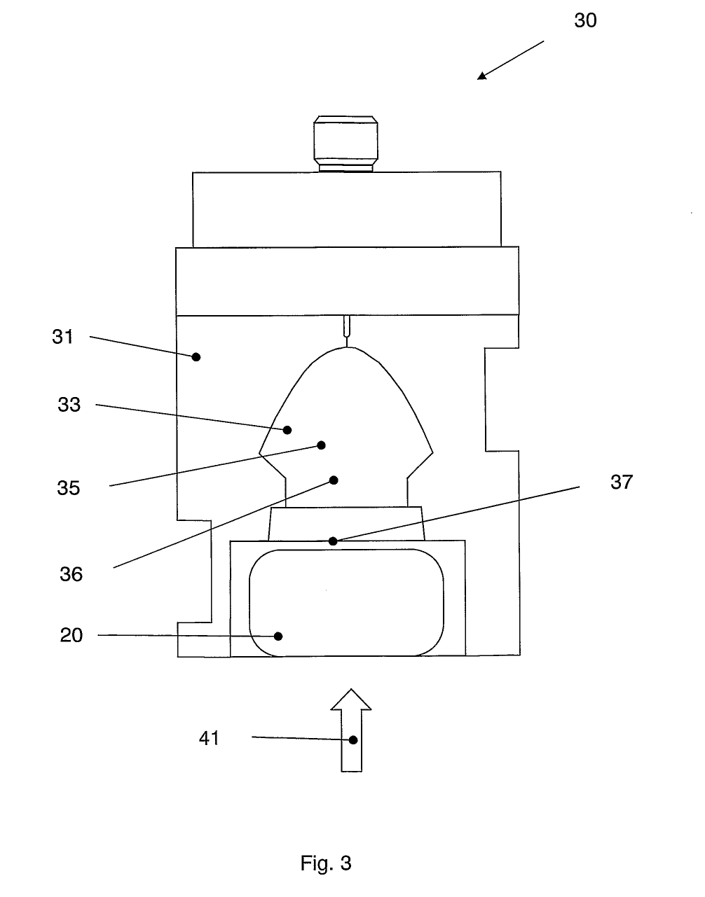

FIG. 3 an example of embodiment of an injection-pressing mould,

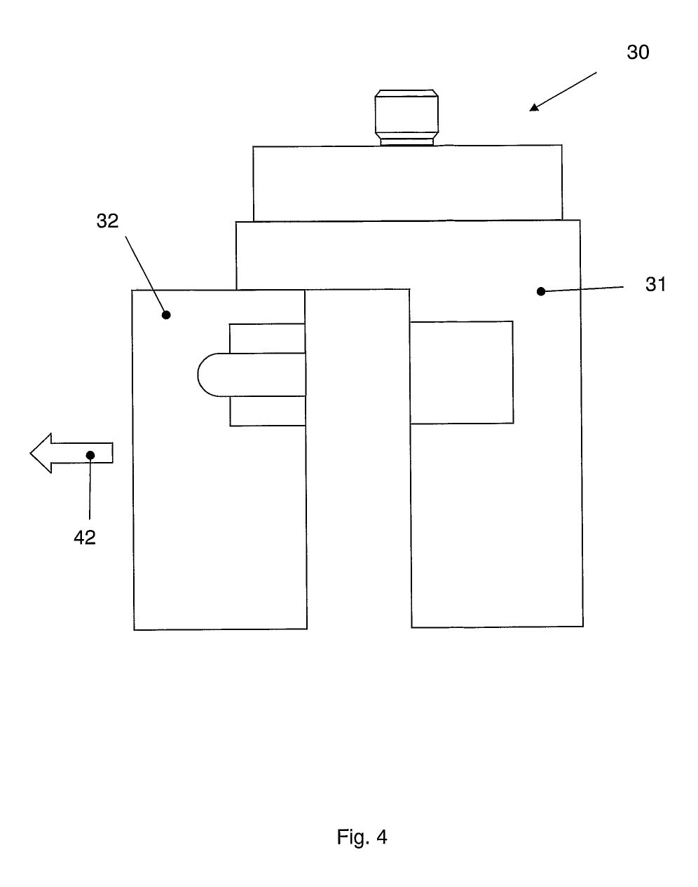

FIG. 4 the injection-pressing mould according to FIG. 3 in an opened state,

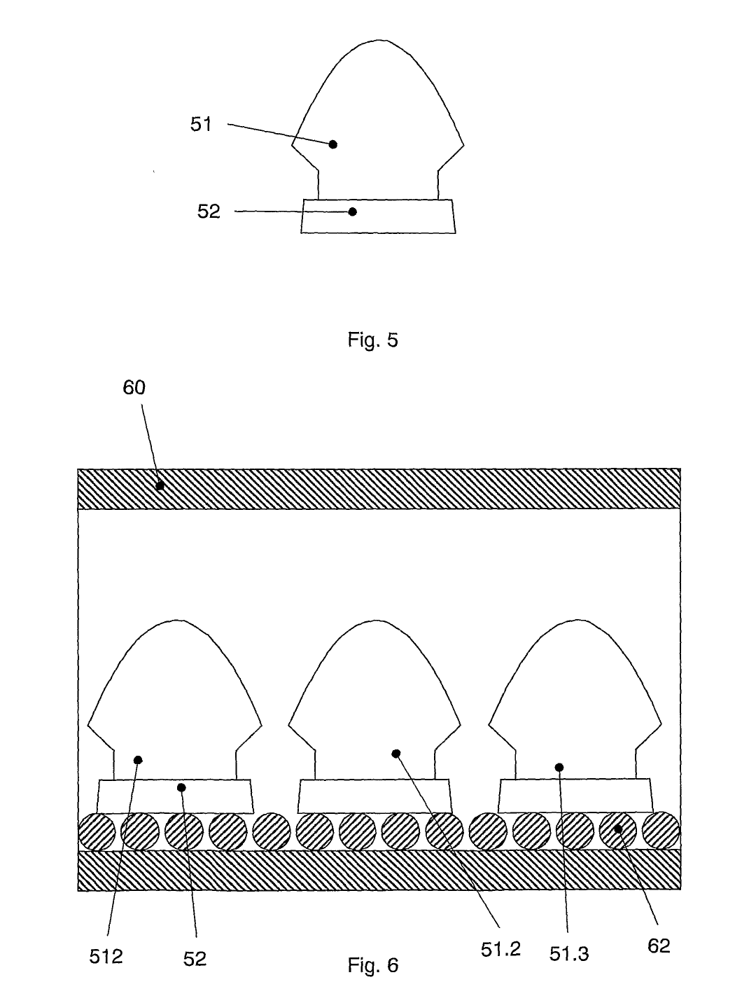

FIG. 5 an example of embodiment of a pressed headlight lens having a cast-on sprue,

FIG. 6 an example of embodiment of a cooling path, and

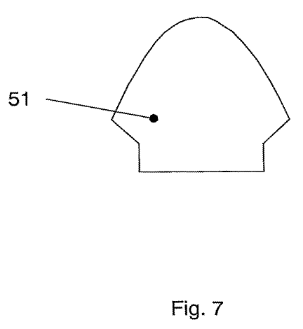

FIG. 7 an example of embodiment of a pressed headlight lens after removing the cast-on sprue.

FIG. 1 shows a process for manufacturing a headlight lens for a vehicle headlight. Herein, a blank is cast from a melted glass mass in a step 10. Subsequently, the blank is cooled, particularly to room temperature, in a step 11, and in a step 12 it is re-heated. One may also provide to combine steps 11 and 12 in one tempering step, wherein the blank is heat-treated such that it obtains an essentially homogeneous viscosity between 10⁴ Pa*s and 10⁵ Pa*s, in particular between 10⁴ Pa*s and 5·10⁴ Pa*s. This viscosity is brought about either in a separate step 12 for heating the blank or in a tempering step in which steps 11 and 12 are combined.

For generating the desired viscosity, the blank 20 is, as has been represented in FIG. 2, heated e.g. on a cooled lance 21 in an oven or furnace 22. Herein, the blank 20 is introduced into the furnace 22 on the lance 21, in particular from below. In a preferred embodiment, the cooled lance 21 is passed by a heated cooling medium or agent flowing through it, and/or passed by a cooling agent or medium flowing through it according to the counter-flow principle. Appropriate embodiments of optional cooled lances may for example be taken from DE 101 00 515 A1. In FIG. 2, the arrow characterized by reference numeral 26 designates an entering cooling medium, and the arrow in FIG. 2 which is designated by reference numeral 25 represents a flowing-off cooling medium. A cooled lance, in particular in the arrangement of the cooled lance 21 is held to represent an expedient embodiment. It may, however, also be substituted by a mandrel (particularly in certain special circumstances).

It may well be provided that the blank 20 be heated in a single furnace. However, it may also be provided that the blank 20 be heated in at least two different furnaces (or one corresponding furnace having different temperature zones), wherein the blank 20 will initially be subjected to a particularly high temperature in a first furnace, and, in a second furnace, will be exposed to a temperature which essentially corresponds to the temperature necessary for bringing about the required viscosity of the blank 20. If the blank 20 has for example been produced from glass of type B270, then the required temperature of the blank 20 will amount to between 900° C. and 1050° C., particularly to around 1000° C.

After heating, and in a step 13 the blank 20 is transferred to a two-part injection-pressing mould 30 represented in FIG. 3, and therein, in a step 14 it is pressed into, i.e. to form a headlight lens. Herein, reference numeral 33 designates the mould cavity of the injection pressing mould 30, which cavity is formed by a mould part 31 and a further mould part which is designated by reference numeral 32 in FIG. 4. The mould cavity 33, in its position designated by reference numeral 35, has a cross-sectional face which is larger than the cross-sectional face of the opening (designated by reference numeral 37) of the mould cavity 33, as well as larger than the cross-sectional face of the mould cavity 33 in a position which has been designated by reference numeral 36. For pressing the headlight lens the blank 20 is pressed, as is depicted by arrow 41, into the mould cavity 33 of the injection-pressing mould from below.

Step 14 is followed by a step 15, in which the readily pressed headlight lens is removed from the injection-pressing mould 30. To this end, the partial moulds 31 and 32 are moved away from one another in a linear movement indicated by an arrow designated by reference numeral 42. In particular, it is provided that the partial moulds 31 and 32 are not to be moved via hinges, i.e. they are not to be swung open. After opening the injection-pressing mould 30, the headlight lens designated by reference numeral 51 in FIG. 5 is taken out and cooled down in a controlled manner in a cooling path designated by reference numeral 60 in FIG. 6, by adding heat (step 16). It is advantageously provided that the headlight lens 51 should be pressed to include a cast-on sprue or section 52. In the cooling path 60 the headlight lens 51 is placed on the cast-on section 52. It may be provided that the cooling path 60 have rollers 62 on which the headlight lenses 51, 51.2 and 51.3 are moved slowly through the cooling path 60, in the course of which movement they are cooled down slowly. After cooling down, the cast-on section 52 is removed in a step 17. The now-ready headlight lens 51 has been represented in FIG. 7.

The elements and layers have been represented in a manner considering simplicity and clearness in the figures, and they not necessarily true to scale. Consequently, the order of dimension, for example, of some elements or layers has been clearly exaggerated with respect to other elements or layers, in order to enhance the comprehension of the examples of embodiment of the present invention.

1-7. (canceled)

8. Method for manufacturing a headlight lens for a vehicle headlight, the method comprising:
heating a blank of glass; and
pressing the blank into an injection pressing mould for forming a headlight lens for a vehicle headlight.

9. Method as claimed in claim 8, wherein the blank is heated such that it obtains a viscosity of between 10⁴ Pa*s and 10⁵ Pa*s.

10. Method as claimed in claim 9, wherein the blank is heated on a cooled lance.

11. Method as claimed in claim 8, wherein the blank is heated on a cooled lance.

12. Method as claimed in claim 8, wherein the blank is heated such that it obtains an essentially homogeneous viscosity.

13. Method as claimed in claim 8, wherein the blank is pressed into the injection pressing mould from below.

14. Method as claimed in claim 8, wherein, for removing the pressed headlight lens, the injection pressing mould is opened by means of a linear movement.

15. Method as claimed in claim 8, wherein, in the injection pressing mould, the headlight lens is pressed to include a cast-on sprue.

16. Method for manufacturing a headlight lens for a vehicle headlight, the method comprising:
heating a blank of glass up to a viscosity of between 10⁴ Pa*s and 10⁵ Pa*s; and
subsequent injection pressing of the blank in an injection pressing mould into a headlight lens.

17. Method as claimed in claim 16, wherein the blank is heated on a cooled lance.

18. Method as claimed in claim 16, wherein the blank is heated such that it obtains an essentially homogeneous viscosity

19. Method as claimed in claim 16, wherein the blank is pressed into the injection pressing mould from below.

20. Method as claimed in claim 16, wherein, for removing the pressed headlight lens, the injection pressing mould is opened by means of a linear movement.

21. Method as claimed in claim 16, wherein, in the injection pressing mould, the headlight lens is pressed to include a cast-on sprue.

22. Method for manufacturing a headlight lens for a vehicle headlight, the method comprising:
heating a blank of glass on a cooled lance; and
subsequent injection pressing of the blank into a headlight lens in an injection pressing mould.

23. Method as claimed in claim 22, wherein the blank is heated on a cooled lance.

24. Method as claimed in claim 22, wherein the blank is heated such that it obtains an essentially homogeneous viscosity.

25. Method as claimed in claim 22, wherein the blank is pressed into the injection pressing mould from below.

26. Method as claimed in claim 22, wherein, for removing the pressed headlight lens, the injection pressing mould is opened by means of a linear movement.

27. Method as claimed in claim 22, wherein, in the injection pressing mould, the headlight lens is pressed to include a cast-on sprue.
